(19) United States
(12) Patent Application Publication
(10) Pub. No.: US 2004/0208523 A1
(43) Pub. Date: Oct. 21, 2004

(54) Swept frequency reflectometry using an optical signal with sinusoidal modulation

(75) Inventors: John C. Carrick, Wakefield, MA (US); Ronald A. Haberkorn, Stow, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL

(21) Appl. No.: 10/060,945

(22) Filed: Jan. 30, 2002

(51) Int. Cl. H04B 10/08; H04B 10/12

(52) U.S. Cl. 398/32

(57) ABSTRACT

An optical line terminal determines an approximate location of impairment in an optical transmission path (e.g., optical fiber) without disconnecting the optical line terminal from the optical transmission path. The optical line terminal generates pilot tones that are modulated on an optical signal and used to make reflection and dispersion measurements in a frequency domain reflectometry manner, thus providing for in-vivo diagnostic testing of the optical transmission path. The dispersion can be automatically corrected by using a dispersion compensator.

### BACKGROUND OF THE INVENTION

Incoherent or direct detection optical frequency-domain reflectometry (OFDR), sometimes referred to as synthetic time domain reflectometry (STDR), is the frequency domain equivalent of a standard pulsed optical time domain reflectometry (OTDR) measurement. This can be understood by noting that the reflected power from a typical test device acts like a linear time-invariant system. This means that a reflectometry trace can be obtained by either measuring the impulse response directly or equivalently, by measuring the frequency-domain transfer function (magnitude and phase of the reflected signal at each modulation frequency) and performing an inverse Fourier transform.

The basic concepts used in coherent OFDR are illustrated in FIG. 1. An electrical vector network analyzer 105 performs a stimulus-response measurement by probing a test fiber 120 with sinusoidally modulated optical power 135 provided by a sinusoidally modulated source 110. The sinusoidally modulated optical power 135 reflects off a test device 125 at two given reflection points, R₁ and R₂. A 3 dB optical coupler 130 directs a portion of the reflected sinusoidally modulated optical power to a high-frequency receiver 115.

A frequency-domain transfer function 140 (i.e., frequency response) is obtained by measuring the amplitude and phase of the reflected signal at each probe frequency. An optical reflectivity versus distance plot 145 is obtained by taking the Inverse Fourier Transform (IFT) of the frequency response 140 and scaling the time axis to represent distance. With IFT, the minimum spatial resolution is inversely proportional to the range over which the frequency is scanned.

For high-resolution reflectometry, OFDR offers several advantages when compared to conventional pulsed OTDR. One advantage occurs in reflection sensitivity since signal averaging can be done more efficiently. This is because the high frequency sinusoidal signals can be measured with a narrow band pass filter. Whereas, in the pulsed case, data collection must be done over the full electrical bandwidth. Another advantage is that higher spatial resolution is easier to implement using OFDR. This is because the frequency response of the measurement electronics can be easily deconvolved from the frequency-domain measurement, allowing the full system bandwidth to be used in determining spatial resolution. See Derickson, D., “Section 10.5.3 Incoherent Frequency-Domain Techniques,” in Fiber Optic Test and Measurement, ISBN 0-13-534330-5, pp. 423-433.

Field installation of fiber used for an optical network suffers various abuses during installation and throughout its lifetime. Currently, power measurements through this fiber is one way to troubleshoot such fibers. Optical frequency-domain reflectometry, described above, and optical time domain reflectometry (OTDR) are also used to look, by way of reflection transit time, for the approximate location of fiber damage.

### SUMMARY OF THE INVENTION

Commercially available equipment, such as shown in FIG. 1, for providing the optical time domain reflectometry (OTDR) or optical frequency domain reflectometry (OFDR) must have personnel to operate it at a location and must disconnect and re-connect the fiber to insert the measurement tool. Dirt ingress or improper reconnection can occur. Further, while these measurements are being made, an optical line terminal to which the fiber is normally connected is no longer available for communication over the optical network path under test, causing downtime of that path on the optical network.

According to the principles of the present invention, an optical line terminal is able to determine an approximate location of impairment in the optical transmission path (OTP) (e.g., optical fiber) or improper connection without disconnecting the optical transmission path from the optical line terminal. In this way, no contaminant can enter connections and no reconnection errors occur. Further, the optical line terminal can check dispersion of the optical transmission path and correct the dispersion by using a dispersion compensator in or composing the optical transmission path.

To make these measurements, an optical line terminal employing the principles of the present invention generates pilot tones that are used to make reflection and dispersion measurements in a frequency domain reflectometry manner. The pilot tones used to estimate the location of impairment in the optical transmission path can be modulated on an optical signal carrying data, thus providing for in-vivo diagnostic testing of the OTP. In other words, network traffic can continue at the same time as fiber diagnostic testing is occurring.

Accordingly, one aspect of the present invention includes a method and apparatus for characterizing an optical transmission path in a network with network traffic. The method and apparatus may be embodied in an optical line terminal (OLT). The optical line terminal modulates an optical signal with a pilot tone. The modulated optical signal is output onto the optical transmission path carrying network traffic. The optical line terminal sweeps the frequency of the pilot tone across a given frequency range. The pilot tone amplitude and phase are detected along a forward path and a reflected path of the optical transmission path. Based on the detected amplitudes and phases, the optical line terminal, or dedicated processor with access to the detected amplitudes and phases executing software designed to interpret the amplitude and phase measurements, characterizes the optical transmission path.

Characterizing the optical transmission path can be used to determine at least one impairment in the optical transmission path. When the optical transmission path is a fiber, the impairment may be a disconnection, contaminant, crimp, obstruction, non-uniformity, defect, or assembly error. Characterizing the optical transmission path can also be used to determine a dispersion in at least a portion of the optical transmission path. The optical line terminal may cause the dispersion to be corrected in an automated manner should the optical transmission path include dispersion correction means.

The detection of the amplitudes and phases in the forward path may be co-located or non-co-located with the detection of amplitudes and phases in the reverse path. When non-co-located, propagation properties, for example, length and velocity of the intermediate optical transmission path between the points of detection have known characteristics.

The optical line terminal sweeps the frequency of the pilot tone across a range of frequencies. As described in Derickson, D., “Section 10.5.3 Incoherent Frequency-Domain Techniques” in Fiber Optic Test and Measurement. ISBN 0-13-534330-5, pp. 423-433, the wider the range of frequencies the better the spatial resolution. But as not described in Derickson, benefit accrues from high signal to noise, such that high spatial resolution can be achieved with more limited frequency range when high signal to noise is available. For example, pilot tones may be swept between about 0.5 MHZ and 2.5 MHZ. The swept frequencies preferably correspond to frequencies essentially absent coherent modulations of the optical signal. The detected optical signals are preferably filtered with a bandwidth sufficiently narrow to reject noise and allow pilot tone detection with high signal to noise ratio. Noise sources can include the random behavior of revenue traffic on an active optical network and can require filters less than 1 Hz bandwidth to achieve needed signal to noise ratios.

The optical line terminal may characterize the optical transmission path based on a relative measurement of amplitudes and phases. In this way, the detection and measurement can be done at any location along the optical transmission path. The optical transmission path may be an optical fiber or free-space. Further, the optical line terminal may be employed in a wavelength division multiplexed or time division multiplexed system.

The principles of the present invention may also be incorporated into a computer-readable medium as stored sequences of instructions capable of being executed by a digital processor.

In one embodiment, the present invention is incorporated into a data communications system that provides optical I/O with data for transfer across the optical transmission path. The data communications system also includes a swept frequency reflectometry subsystem including (i) a modulation means to apply modulation to the data across a frequency range in a swept manner, (ii) detection means to detect the modulation along forward and reflected paths in the optical transmission path, and (iii) processing means to characterize the optical transmission path based on the forward and reflected paths amplitudes and phases.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a prior art system used to determine a location of an impairment in an optical transmission path in a fiber optic network;

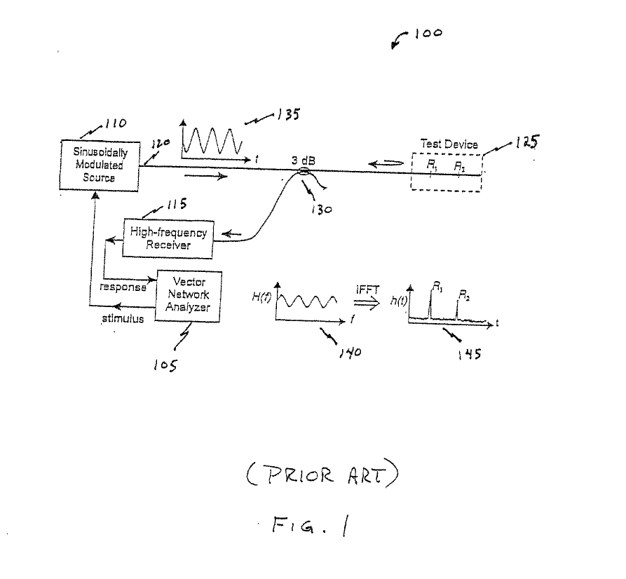

FIG. 2 is a block diagram of an example optical network in which at least one optical line terminal employs the principles of the present invention;

FIG. 3 is a schematic diagram of a subset of the optical network of FIG. 2 having a pilot tone being used to determine a location of an impairment in an optical transmission path;

FIG. 4A is a schematic diagram of devices used by the optical line terminal of FIG. 2 used to provide the pilot signal, detect the transmitted and reflected pilot tone, and process the detected pilot tones to determine the location of an impairment or dispersion in the optical transmission path;

FIG. 4B is a block diagram of an alternative embodiment of the optical line terminal of FIG. 4A having a tunable dispersion compensator;

FIG. 4C is a flow diagram of a process used in the optical line terminals of FIGS. 4A and 4B to take a reflection measurement for a single wavelength;

FIG. 4D is a flow diagram of a process used by the optical line terminal of FIG. 4A to take a reflection measurement of at least two wavelengths to measure chromatic dispersion;

FIG. 4E is a flow diagram of a process used by the optical line terminal of FIG. 4A to compensate for the chromatic dispersion;

FIG. 5 is a block diagram of a modulator in the optical line terminal being fed data and pilot tone information to be applied to an optical signal being output to the optical transmission path;

FIG. 6 is a plot of an optical velocity versus optical frequency of the optical signal of FIG. 5 output onto the optical transmission path;

FIG. 7 is a logic signal diagram corresponding to the optical signal of FIG. 5 that demonstrates dispersion effects caused by dispersion within the optical transmission path;

FIG. 8 is a signal diagram of the optical signal of FIG. 5 having various waveforms of modulations on the optical signal;

FIG. 9 is a spectral diagram of intensity versus frequency of the optical signal of FIG. 5;

FIG. 10 is a scatter diagram of phase versus frequency having data points corresponding to sweep frequencies of the pilot tone provided by the optical line terminal of FIG. 3;

FIG. 11 is a phasor diagram of measured amplitude of the pilot tone used by the optical line terminal of FIG. 3;

FIG. 12 is a block diagram of an alternative optical network of FIG. 3 having a section of the optical transmission path having dispersion compensation;

FIG. 13 is a time chart of optical modulation resulting from transmission in the optical transmission path of the network of FIG. 12;

FIG. 14 is a block diagram of the optical network of FIG. 3 detecting the pilot tone at various locations within the optical network; and

FIG. 15 is a block diagram of an alternative embodiment of the optical line terminal of FIG. 3 employing time or frequency division multiplexed technology.

### DETAILED DESCRIPTION OF THE INVENTION

A description of preferred embodiments of the invention follows.

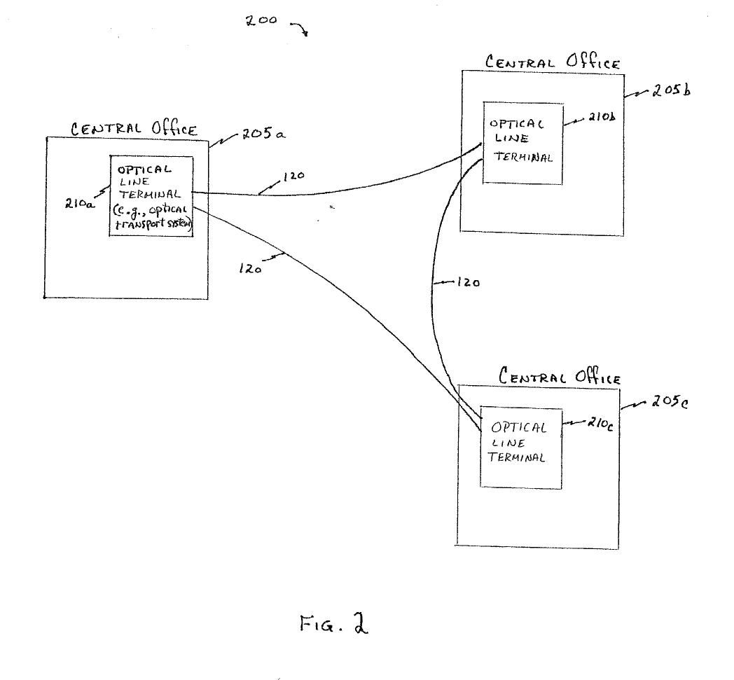

FIG. 2 is a block diagram of an optical network 200 in which data flows among three central offices 205a, 205b and 205c (collectively 205). The central offices 205 include optical line terminals 210a, 210b, and 210c (collectively 210), respectively. An example of an optical line terminal (OLT) is an optical transport system, such as a Tellabs® TITAN® 6100 Optical Transport System (OTS) or an optical switch.

The optical line terminals 210 are interconnected by an optical transmission path 120, such as a fiber optic cable or free space. The fiber optic links 120 may be connected directly or passed through “patch panels” or other interconnecting mechanism. Further, optical routers or repeaters may be employed at one or more locations along the optical transmission paths 120.

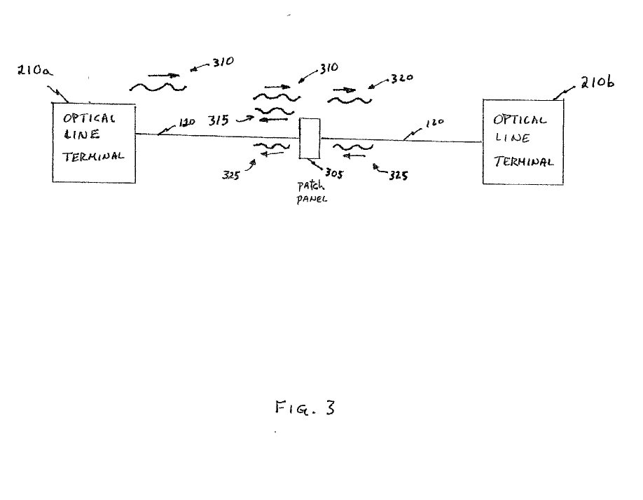

FIG. 3 is a block diagram of the first optical line terminal 210a communicating with the second optical line terminal 210b. The optical transmission path 120 includes a patch panel 305. At the patch panel 305, an impairment in the optical transmission path 120 is experienced by optical signals traveling in one or both directions. When the optical transmission path 120 is a fiber optic cable, this impairment may be caused by a disconnection, crimp, obstruction, contaminant, defect, assembly error or manufacturing tolerance at the patch panel 305.

Typically, the optical line terminals 210 transfer data between each other. Here, the first optical line terminal 210a also transmits a pilot tone 310, optionally concurrently with transmitting data. The pilot tone 310 is a low-frequency compared to optical frequencies and applied as a modulation to an optical signal. When traveling in the optical transmission path 120, a small amount of the transmitted optical signal modulated with the pilot tone 310 (referred to hereafter as just the pilot tone 310) is reflected by the impairment in the patch panel 305 and returned to the optical line terminal 210a. The reflection is referred to as a first reflected pilot tone 315. The first reflected pilot tone 315 has an amplitude and phase different from the transmitted pilot tone 310 as observed at the exit of the first optical line terminal 210a. The rest of the transmitted pilot tone 310 passes through the impairment in the patch panel 305 and is represented as a pilot tone 320 having the same phase as the transmitted pilot tone 310. A reflection from the second optical line terminal 210b is represented as a second reflected pilot tone 325.

The optical line terminal 210a employing the principles of the present invention is able to determine the location of the impairment in the optical transmission path 120 at the patch panel 305 within a reasonable resolution for a technician to locate and correct the impairment. It should be understood that the impairment may not in fact occur at the patch panel 305 but may instead be located anywhere along the optical transmission path 120, including locations relatively close to the optical line terminal 210. In some cases, all that may be necessary to determine is whether the impairment is located closer to the first optical line terminal 210a or closer to the second optical line terminal 210b.

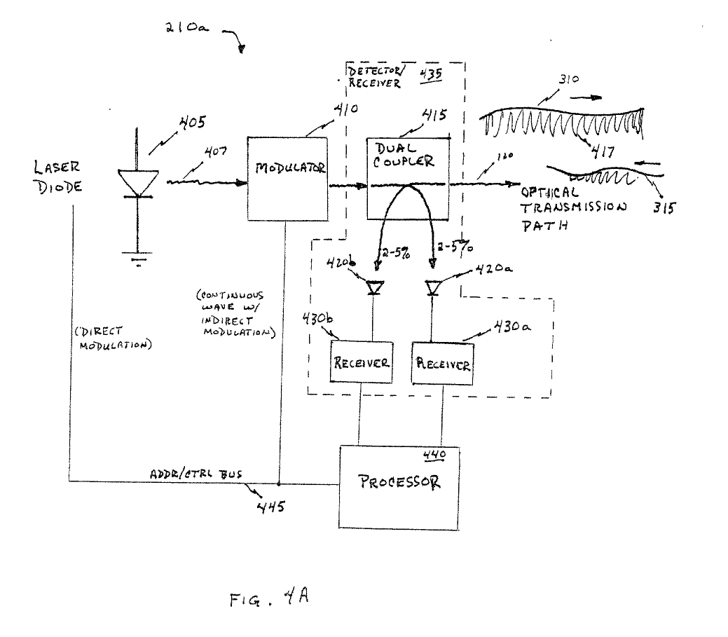

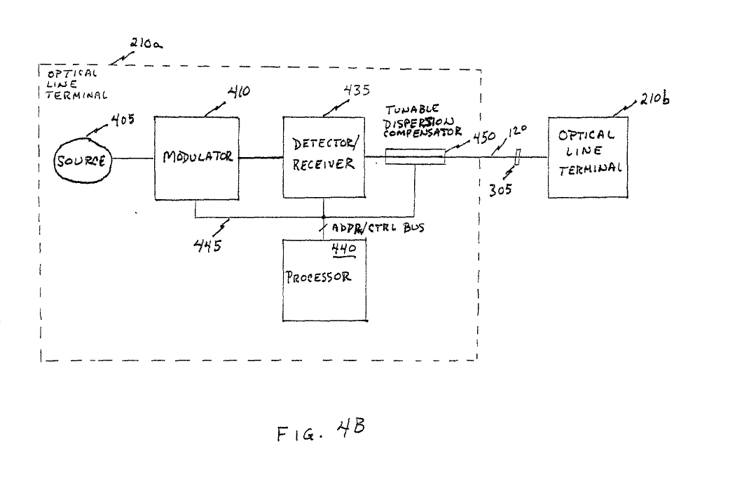

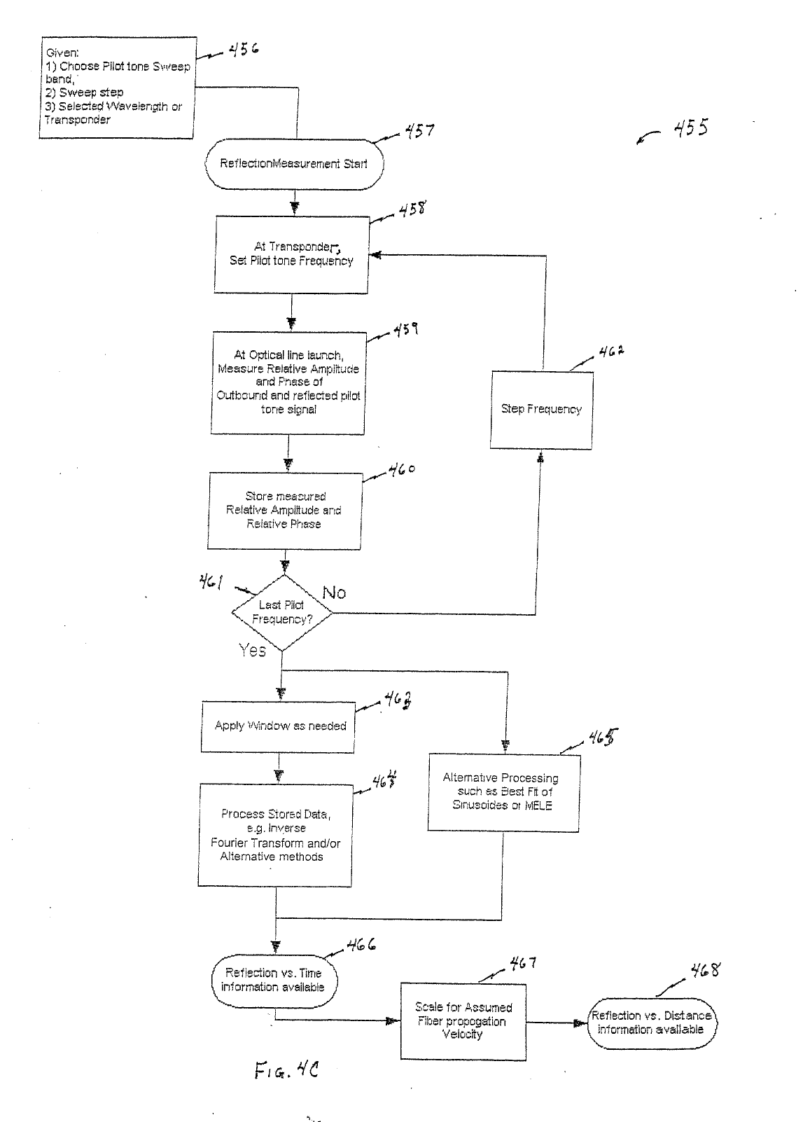

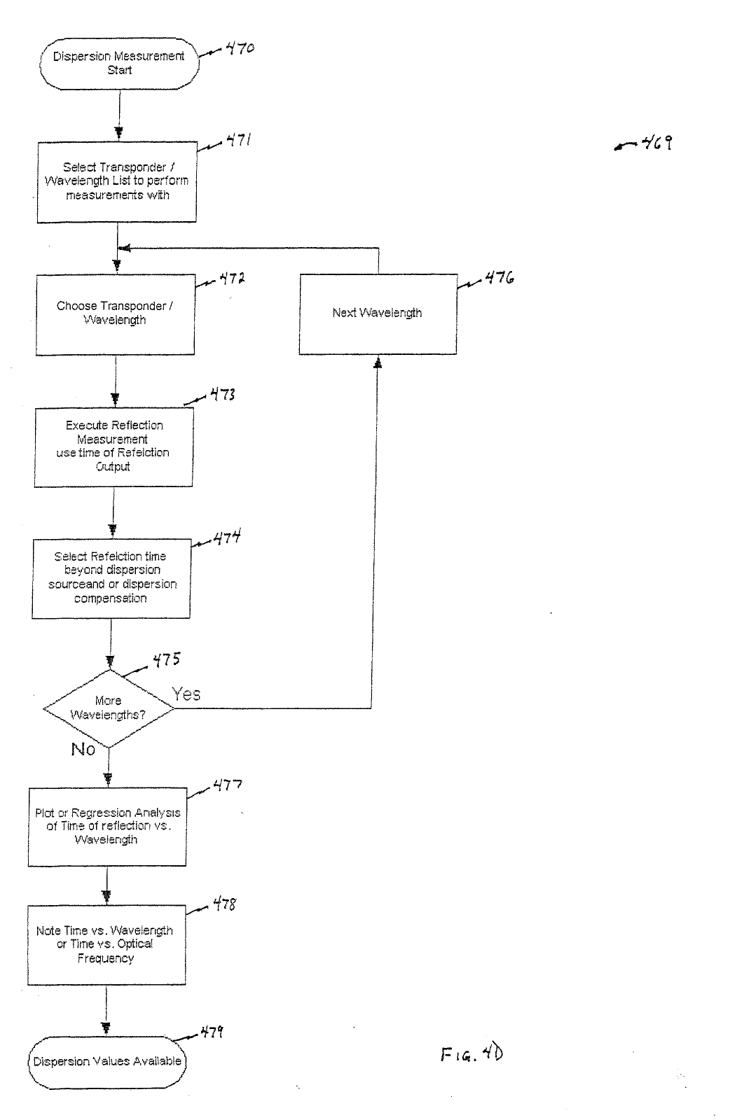

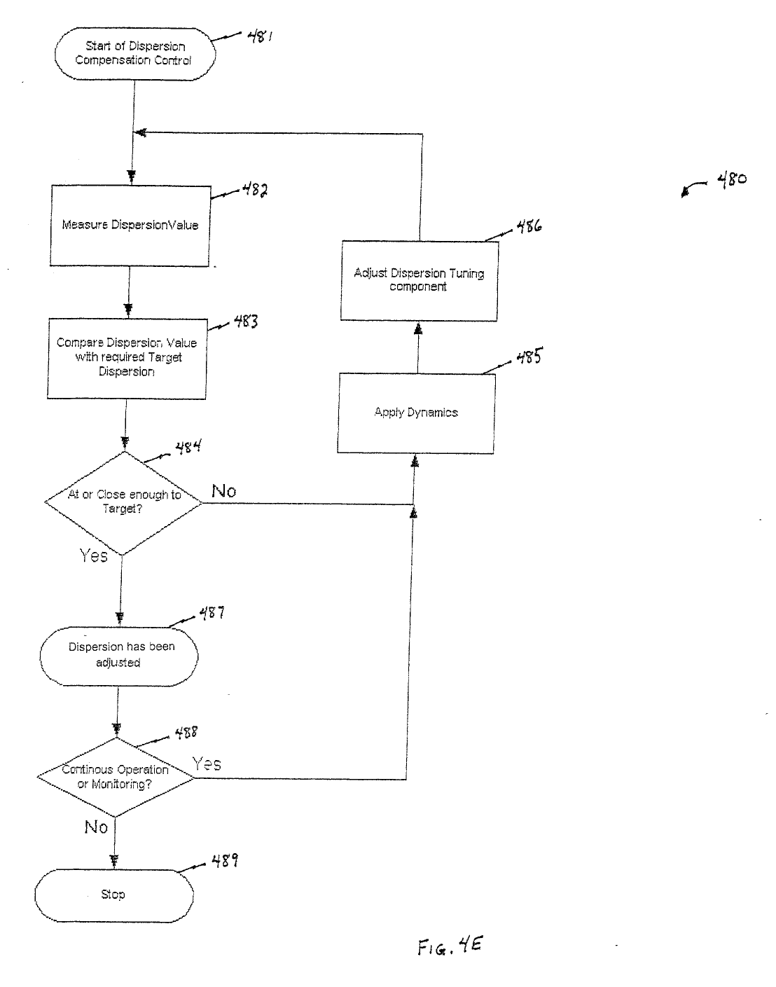

FIG. 4A is a detailed schematic diagram of the optical line terminal 210a and exemplary components included therein. The optical line terminal 210a includes a laser diode 405 and a modulator 410, such as an electro-absorptive modulator or Mach-Zehnder modulator. These two devices can be used as an optical source for the swept frequency reflectometry (SFR). As indicated by the pilot tone 310, the first optical line terminal 210a can provide normal data traffic—represented as high frequency optical data 417—throughout the SFR activity. The high frequency optical data can be any possible modulation format on the optical signal that does not have significant coherent spectral content at the pilot tone frequencies used for measuring amplitude and phase of the reflected optical signal. The high frequency optical data can be on-off keyed, or modulated sub-carrier, or combinations there off as described in the literature, or the data can be modulated with other modulation formats.

In the case where a pilot tone frequency would have been used, but there is a significant coherent spectral component in the optical traffic at that frequency, the spectral component may be used as the modulation frequency for probing the amplitude and phase of the reflected optical signal. This is possible because the measured values at the output of the first optical line terminal 210a are relative between the transmitted pilot tone 310 and the first reflected pilot tone 315. Optical signal details of that spectral component, such as different amplitude compared with other regular pilot tones, may make this signal less convenient to use as a probe signal, although it is possible in principle.

A processor 440 provides control signals over an address/control bus 445 to the laser diode 405 and/or modulator 410. The control signals include commands for modulating a laser beam 407. When controlling the laser diode 405, the processor 440 performs “direct” modulation. When controlling the modulator 410, the processor 440 provides “indirect” modulation of a continuous wave of the laser beam 407. A combination of the processor 440 and laser diode 405 and/or modulator 410 is hereafter referred to as a pilot tone generator. Other pilot tone generator configurations are suitable.

The amount of amplitude modulation provided by the transmitted pilot tone 310 is about 4% of the total amplitude of the optical signal 417. In other words, the amplitude of the transmitted pilot tone 310 divided by the amplitude of the total envelope of the optical signal 417 is 0.04, or 4%. The actual value of 0.04 is not important for SFR because the measurement of the transmitted pilot tone 310 and reflected pilot tones 315 and 325 is ratio-metric. The value 0.04 is chosen to have predictably small or negligible impact on other modulations present in the optical traffic. The value is such that pilot tones not used for SFR may be used for other reasons in the optical network. Such reasons include wavelength ID tags and other reasons described in the literature.

The pilot tone generator is stepped through pilot tone frequencies operating between about 0.5 MHZ through about 2.5 MHZ, discussed more later, while skipping any previously allocated pilot tones or coherent modulations present in the optical transmission path links 120 through which the SFR is performed.

At the normal connection to the optical transmission path 120, a dual directional coupler 415 is provided and pilot tone detectors 420a and 420b (e.g., photodiodes) receive optical signals from the forward coupled port and reverse coupled port, respectively. Typically, the dual directional coupler 415 splits about 2-5% of the optical signal traveling in each direction for detection by the detectors 420a and 420b. Separate unidirectional couplers joined in opposite direction can perform the equivalent task as the dual directional coupler in this application, as should be clear to one skilled in the art.

Pilot tone receivers 430a and 430b (collectively 430) are coupled to respective pilot tone detectors 420a and 420b. The pilot tone receivers 430 are standard pilot tone receivers of the TITAN 6100 optical network, except that a provision may be made to maintain relative phase information about received signals directed by the two pilot tone receivers 430 and are tuned along with the frequency sweep of the transmitted pilot tone 310. A feature of the standard TITAN 6100 pilot tone receiver is an ability to adjust its detection bandwidth. For this application, the pilot tone receiver allows the detection bandwidth to be made narrow so as to achieve high signal to noise ratio needed for accurate refection localization The dual coupler 415, detectors 420, and receivers 430 are collectively referred to as a pilot tone detector/receiver 435. Information regarding relative return amplitude and relative phase of the pilot tone 310 is stored as the frequency sweep progresses.

The frequency sweep is preferably of a sufficiently fine increment that the relative amplitude and phase information is roughly continuous. Data points that are skipped due to frequencies at which other pilot tones or other coherent modulations are already allocated may then be interpolated as needed. Alternatively, other data reduction methods with sparse data may be invoked.

After the frequency sweep is complete, an Inverse Fourier Transform is executed on the compiled data, which converts the frequency domain of the pilot tone 310 to the time domain of the reflected pilot tones 315 and/or 325 (FIG. 3). Utilizing propagation parameters for the optical transmission path 120, the time information can be converted to location information.

Swept frequency reflectometry with electrical signals in the radio frequency band yields information about the angle and magnitude of the reflections being measured. The angle relates to the reactance and resistance of the circuit doing the reflecting, with the reactances being those that occur at the radio frequency used in the test. Because the radio frequency is swept and because phase information about the launched received radio waves is collected, reactance versus frequency information is obtained, and the reactances can be evaluated. This is in addition to the magnitude. However, doing swept frequency reflectometry with an optical signal with pilot tones only measures the magnitude of the reflection because the reactance information corresponds to the reactances that occur at the carrier or optical frequency, and the phase of the optical carrier is unknown. The optical phase is unknown because the pilot tone receivers are not sensitive to optical phase. Optical reflection magnitude as a function of optical frequency is available by varying optical frequency.

The pilot tone receivers 430 show single channel, single receiver repeatability of better than 0.1 dB optical, which implies an ability to sense angles to 0.0233 radians. This is due to the high signal-to-noise ratio available with narrow detection filters (not shown) in the receivers 430. For fiber optic cables, the wavelength of pilot tones (not the optical carrier) is 136 to 272 meters with current pilot tone frequency assignments. This angle resolution translates to an ability to resolve distances of +/−0.5 to 1.0 meter. With two receivers 430a and 430b operating simultaneously and doing relative measurements for this SFR, angle accuracy and range resolution are better than 0.5 meters.

A total frequency width of the frequency sweep of the pilot tone 310 relates to an apparent time width after the Fourier processing. A wider frequency sweep results in a narrower FFT time output, which typically provides better results. Current pilot tone electronics operate from less than 500 KHz to more than 2.5 MHZ, or across more than 2 MHZ. This yields FFT output time increments at 500 nanoseconds or about 50 meters in the optical transmission path 120 being measured. A good signal-to-noise ratio allows good interpretation as to a time of reflection finer than this 500 nsec. Single reflection events isolated by more than say 200 meters should be measurable to the 1 meter resolution available from the angle resolution, as discussed above. Additional processing after the FFT, or instead of the FFT, can be applied to locate the best apparent peak between FFT time bins. Other processing methods, such as finding best fit reflections, may also be useful. Multiple reflections within 50 meters of each other are discernible based on this angle resolution. Alternatively, best fit processing may be employed rather than FFT processing.

The frequency step increments of the frequency sweep of the pilot tone 310 relate to a maximum cable 120 length being measured. The frequency sweep step resolution size should be small enough such that a round trip phase change across this frequency step is less than 2π. Then, the phase slope versus pilot tone frequency may be discerned without ambiguity. If the phase changes more than 2π, aliasing can occur in the FFT processing and the reflection location can be misinterpreted. This relates the step size to the maximum optical transmission path fiber length being measured. For example, 40 Km of optical transmission path 120 requires frequency steps of less than 2.5 KHz, easily attainable with present pilot tone circuitry.

A finite directivity of the dual coupler 415 used for sensing the transmit and reflected optical signals with pilot tones 310 is one source of error in this technique. For example, a Newport F-CPL-L22151-A provides a directivity of >55 dB. For roundtrip path losses of less than 36 dB (approximately 60 Km of fiber), the error from this leakage is less than about 1 meter.

Return loss of the photodiodes 420a and 420b in the detector/receiver 435 is another error source. For example, reflection from photodiode 420a may arrive in photo diode 420b and couple the forward signal to the reverse signal. Photodiode return losses greater than 40 dB are available; a return loss of 45 dB makes this error comparable to the error from directivity. Also, use of separate couplers for forward and reverse coupling can minimize this error with a cost of additional main output path insertion loss.

As with just about any Fourier transform application, it may be beneficial to apply known windowing techniques to the data prior to DFT or FFT processing. Windows provide an ability to trade off resolution for artifacts related to edges of the source data domain.

Swept frequency reflectometry with a wider band of pilot tone frequencies provides better time resolution at the Fourier output prior to the additional processing that relies on the good signal-to-noise ratio for resolving small distance changes. A wider band of pilot tones provides better time and distance resolution. Higher frequencies for pilot tones shorten the pilot time wavelength in the optical transmission path 120 and provide better distance resolution.

Swept frequence reflectometry can be applied to the Optical Supervisory Channel (OSC) or any optical signal with a known narrow band amplitude modulation (AM) that can be tuned across a band. The narrow band requirement is that the phase and amplitude coherence of the transmitted pilot tone 310 is maintained or known during the round trip propagation and returned as reflected pilot tones 315 and/or 325. If this requirement is met, then relative phase and amplitude can be extracted and for each narrow band AM frequency sent, and the information required for SFR processing is available.

As described so far, the optical frequency is that of a single transponder (not shown) in the optical line terminals 210. Most fiber impairments affect most of the 1525 to 1565 nm band about the same, where a fractional change of wavelength is small across the band. However, some narrow band impairments can exist. These can be searched for by operating this swept frequency reflectometry activity on additional transponders, which are at additional wavelengths. In this way, a more complete characterization of a given reflection is obtained, where the additional information includes variations along the optical frequency axis.

The change in transponders and probing wavelength exercise chromatic dispersive properties of the optical transmission path 120. The correctness of dispersion compensation can be checked by measuring the round trip delay of some fixed reflection beyond the compensation and beyond the transmission path's dispersive contribution. By measuring at the extremes of wavelength of 1525 nm and 1565 nm, and doing each of these measurements to an accuracy of 1 meter as described previously, implies time resolution of about 5 nSec. Thus differences in round trip propagation time between these wavelength extremes of more than 5 nSec will be observable. This difference in propagation time across a 40 nm change in wavelength is dispersion and the implied measurement resolution is 5 nSec/40 nm=125 ps/nm. This level of resolution for measuring chromatic dispersion is useful when dealing with 10 Gigabit per second optical signals, such as SONET protocol OC192.

FIG. 4B is a schematic diagram of the optical line terminal 210a that includes a tunable dispersion compensator 450. Here, the processor 440 controls the tunable dispersion compensator 450 via an address/control bus 445. The tunable dispersion compensator 450 is operated in a closed-loop, whereby an error signal is determined by the processor 440 using the above described dispersion measurement. The closed-loop process allows the optical network 200 (FIG. 2), for example, to be automatically optimized for dispersion effects present in the optical transmission paths 120. Alternatively, the tunable chromatic dispersion compensator 450 may be at the far end of path 210a, and control information is transmitted from processor 440 to compensator 450 via network management messages and network management message paths not shown but of a variety known in the industry.

It should be noted that time domain reflectometers used by field installation personnel typically have measurement resolutions on the order of five meters (see specifications for EXFO FTB-7523B-B, manufactured by EXFO Electro-Optical Engineering, Inc.). Pilot tone swept frequency reflectometry provides comparable accuracy. In some cases, lab time domain reflectometers perform better than pilot tone swept frequency reflectometers, but for field use, sometimes all that is needed is knowing an approximate location of a cause of a reflection.

In order to control dispersion compensation, the optical line terminal 210a measures dispersion in the optical transmission path 120. In order to measure dispersion, the optical line terminal 210a measures reflection versus wavelength or equivalently versus optical frequency. The measurement process may start with measurement of reflection for one optical frequency.

FIG. 4C is a flow diagram for performing a reflection measurement for a single transponder or wavelength in an optical line terminal 210a carrying traffic. The results of the measurement are available in either time of reflection format or distance to reflection format. As describe previously, a pilot tone source is stepped through a frequency band (steps 458 and 462), with relative amplitude and phase measured and recorded (steps 459 and 460) for each pilot tone frequency.

After completion of the sweep (step 461) the collected amplitude and phase information is subjected to either an inverse Fourier transform or alternative data reduction method (steps 463 and 464 or step 465) so as to extract time vs. reflection information. The choice of inverse Fourier transform or alternative data reduction depends on the accuracy of the desired result, the signal-to-noise available in the source data, and computation time available. Alternative data reductions methods include, but are not limited to, maximum likelihood estimation (MLE) (known in the industry) and mean likelihood frequency estimation (MELE) (known in academia).

For example, MLE computation time can be large when many reflections are anticipated or reflections are closely spaced. In the case where reflections are few or are well separated, MLE provides higher localization accuracy than an inverse Fourier transform. Then, after processing (steps 464 or 465), either result can typically be presented as a graph (not shown) representing magnitude of reflection vs. time or distance (steps 466-468). Typically, there may be more than one peak in this graph representing multiple reflection events or locations.

For dispersion measurements, generally alternative processing (step 465), such as MLE or MELE, is used rather than a relatively simple inverse Fourier transform. For dispersion compensation, the time of reflection return is the relevant reflection measurement output.

In order to measure chromatic dispersion, time of reflection is measured for two or more different optical frequencies. Some specific reflection beyond the source of chromatic dispersion or chromatic dispersion plus compensation is selected from each reflection measurement. The specific reflection should be somewhat isolated such that it is clear that it is indeed the same particular reflection event that is being selected from each optical frequency's reflection graph. The time of reflection is slightly different for each optical frequency used since the time of reflection is a function of optical frequency. The change in time of reflection divided by the change in optical frequency is the total chromatic dispersion for the length of fiber carrying the optical signal.

FIG. 4D captures the above process for measuring chromatic dispersion. As many optical frequencies as are available are selected and used (step 471), where the number of optical frequencies is at least two. For each optical frequency (steps 472 and 476), reflection vs. time is collected as per the process of FIG. 4C. From each of those results, the time of reflection for an isolated event is identified and selected (step 474). After the isolated reflection event's time for each optical frequency is available, delta time vs. delta optical frequency is obtained, preferably by regression methods (step 477), but perhaps by graphical techniques. The ratio of delta time divided by delta optical frequency is the chromatic dispersion for the round trip propagation path between the sensing location and the reflection event (steps 478-479).

Chromatic dispersion in optical fiber is typically a function of optical frequency, with a known algebraic relation. For example, a Corning® SMF-28 optical fiber data sheet provides an algebraic expression for chromatic dispersion as a function of wavelength which can be converted to optical frequency. In cases where the dispersion source being measured has known algebraic relations with optical frequency, this known relation can be used in the regression analysis (step 477) to provide a better data fit than simple linear regression might yield.

In order to control dispersion, a variable dispersion compensation device is needed, and a method of measuring total dispersion is employed. The previous dispersion measurement method can be used when an isolated reflection event is available beyond the dispersion source and beyond the compensation. An example of when such an isolated reflection event is typically available is at optical network installation. During installation, the far end of a fiber path including a compensation means may be temporarily disconnected. The unconnected fiber generates a reflection that traverses the optical path and compensation device.

An alternative time such an isolated reflection event may be available is during normal network operation with revenue traffic. Most connectors and splices used in optical networks generate reflections to some degree. The task of selecting the reflection event becomes a bit more difficult by the smaller size of the reflection compared with a typical fiber end as above, but typical optical line terminal installations provide enough connections and splices to provide high likelihood of finding a suitable reflection event. Alternatively, a specified reflection may be incorporated in the optical transmission path to provide certainty of the presence of a reflection suitable for dispersion measurement, at an expense of some fraction of transmitted power.

To control the chromatic dispersion, the variable dispersion compensation devices is adjusted while monitoring measured dispersion. The adjustment is made so as to make the dispersion either small enough or of a particular value.

FIG. 4E captures the above dispersion control process. The process begins (step 481) with an initial measure of dispersion (step 482) as described in FIG. 4D. The resulting dispersion is compared with a target dispersion (step 483), typically zero. If the dispersion is close enough to the target (step 484), the dispersion compensation is correct (step 487) and no further action is necessary, although the dispersion measurement may be repeated (step 488) as a network health and status monitor to observe, for example, fiber aging or environmental effects on the transmission path. If the dispersion is too far from the target, the adjustable dispersion compensation device may be adjusted (step 486) to reduce the dispersion. The dispersion may be again re-measured and the adjustment iterated. As with any control loop, depending on the response time of its components, there is a possibility for instability. Appropriate dynamics (step 485) can be inserted in the control feedback path to prevent instability as shown in the figure.

Thus, the dispersion may be controlled using refection measurements performed by SFR using pilot tones operated at multiple optical frequencies during network operation.

Programs to perform the above described steps may be embodied in software executed by the processor 440. The software is stored in a computer-readable medium, such as a ROM, CD-ROM, magnetic disk, or other computer-readable medium. The processes 455, 469, and 480 assume that the processor 440 is in communication with a modulation means 410, detector/receiver means 435 capable of carrying out the operations described above, and, for the dispersion compensation process 480, dispersion compensation means 450.

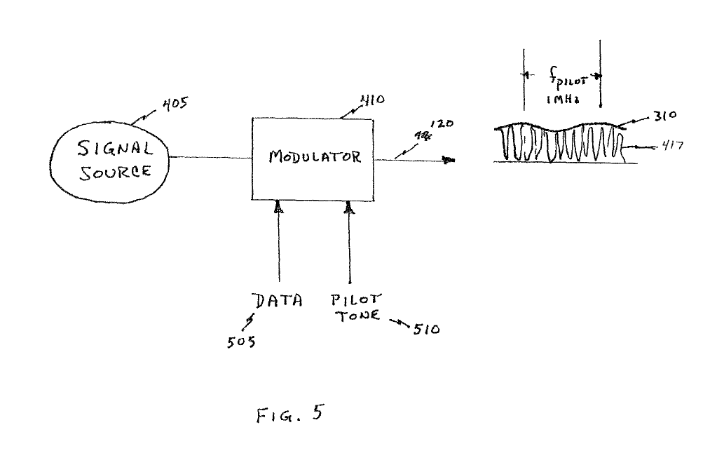

FIGS. 5-15 include additional details and alternative embodiments of the principles of the present invention as described above.

FIG. 5 is a schematic diagram of a subset of components of the optical line terminal 210a. The modulator 410 is used to modulate the output from the signal source 405, which provides the pilot tone 310 used for detecting (i) impairment in the optical transmission path 120 or (ii) a dispersion in the optical transmission path 120.

The modulator 410 receives a pilot tone command 510 for modulating the output from the signal source 405. The modulator 410 may also receive data 505 for modulating the same output from the signal source 405. Both the data 505 and pilot tone command 510 may be provided directly from the processor 440 (FIG. 4B) or the signals may be provided by a separate circuit (not shown) specially designed to provide one or both signals.

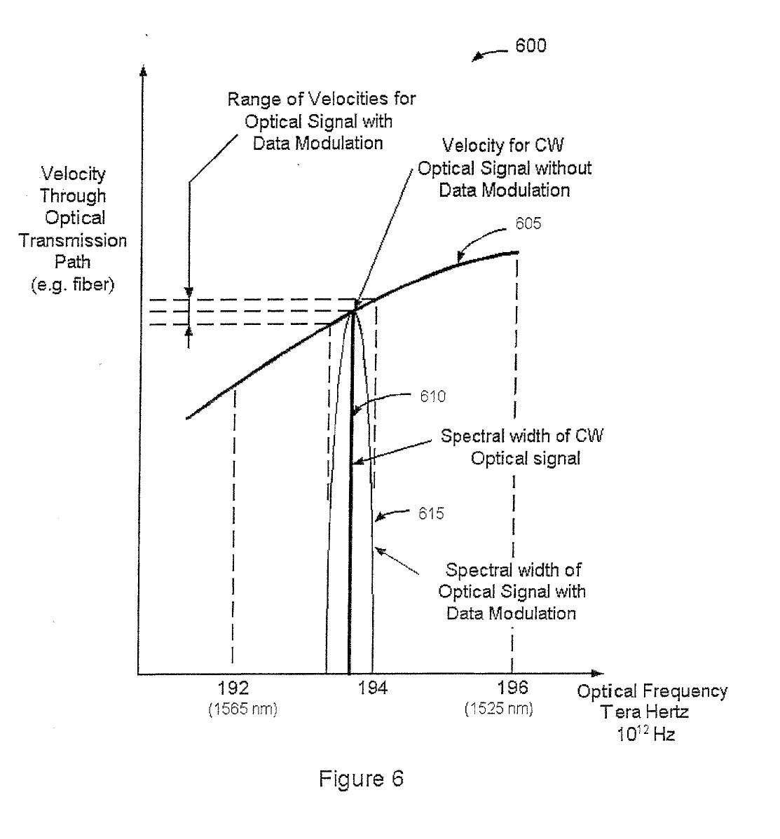

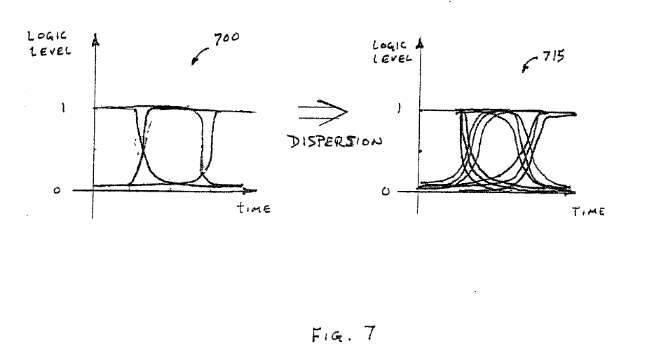

It is known in the industry that dispersion effects that have a time effect of a one eighth of the time of a bit are of interest. This sort of effect for chromatic dispersion is illustrated in FIGS. 6 and 7. FIG. 6 shows the spectral width of an optical signal with perhaps 10 Gbit/sec data 615. After propagating in the optical transmission path 120, the optical signal might appear, as shown in FIG. 7, as “eye” diagram 715, where its signal integrity has been compromised by perhaps ⅛ of a bit time (compare against a non-dispersion affected eye diagram 700). This compromise arises from chromatic dispersion due to the various components of the data 615 propagating at various rates shown by a curve 605 in FIG. 6. The width of the data 615 is on the order of 10 GHz for 10 GBit/sec data. Noting that a bit time is 0.1 nanoseconds allows an estimate of a useful measurement accuracy related to chromatic dispersion, (0.1 nsec/bit)×(⅛ bit)/10 GHz=D 1.25e-21 sec/Hz. If this amount of dispersion is present across 4 THz, it represents a time variation of 1.25e-21 sec/Hz×4e12 Hz=5e-9 or 5 nSec. Therefore, the ability to resolve 5 nanosecond time intervals when optical signals may be spread by 4 THz is useful for chromatic dispersion related measurements. SFR with pilot tones in a wavelength division multiplexing system that spans 4 THz provides this useful chromatic dispersion measurement capability.

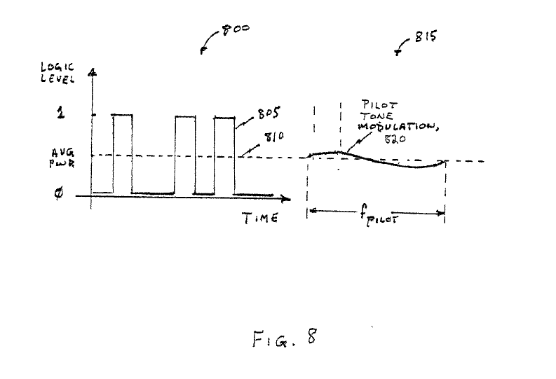

Various optical modulations can be used with pilot tones. In the current embodiment, on-off keyed data operates with the pilot tone. FIG. 8 includes timing diagrams of logic signals transmitted across optical transmission path 120. An idealized mathematical representation of the intensity of the optical signal effected by FIG. 8 is

I(t)=Pave*(2*D(t))*(1+M*sin(2*PI*Fp*t)),

where I(t) is the optical intensity of the composite optical signal as a function of time t is a time in seconds. D(t) represents a random bit stream carrying network revenue traffic, taking on values of +1 or 0, such that the time average value of 2*D(t)=, Pave represents the time average optical power or intensity in watts, M is the modulation index, PI=π=3.14159, and Fp is the pilot tone frequency in Hz.

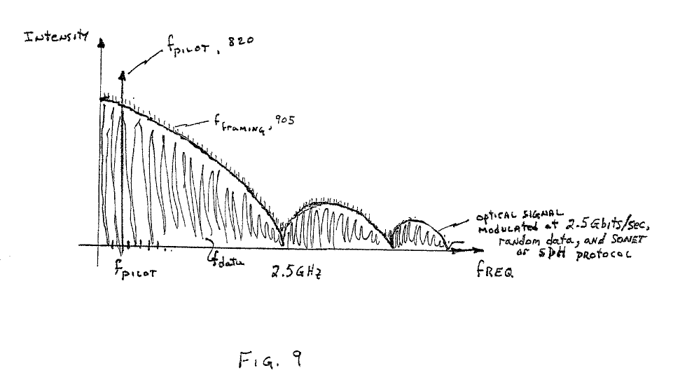

FIG. 9 shows the spectrum of I(t). Due to the random nature of D(t), there is a broad continuum in the spectrum that represent the energy associated with the on-off keying of the data. It is noise-like in the sense that it does not have discrete spectral lines and in the sense that reducing the resolution bandwidth of this spectrum results in a drop in the power within that resolution bandwidth.

In practice, D(t) is not completely random. Typical modulations used in optical transport have a small fraction of their bits devoted to protocol functions. In one embodiment, the Synchronous Optical NETtwork (SONET) protocol is assumed. The SONET protocol devotes approximately 4% of transmitted bits to these protocol functions. These protocol functions tend to be repetitive and not random, for instance, bits with framing information repeat every 125 uSec. The repetitive nature of these 4% of bits results in discrete spectral lines within the ideal noise continuum, and in our embodiment are shown in the spectrum of FIG. 9 as small “hair”, and are labeled “f_{framing} 905”. Due to their repeat time of 125 uSec, the lines of hair have a spacing of 8 KHz. The remaining 96% of transmitted bits do behave in random fashion for networks carrying revenue traffic. What this all means for the embodiment being described is that for resolution bandwidths of less than 8 KHz, and positioned between lines representing f_{framing} 905 such that these lines are rejected by this resolution bandwidth, the spectrum does behave in the ideal, noise-like manner. The specific data rate is not too critical, but for this embodiment, it happens to be SONET OC48, or approximately 2.5 GBits per second.

The spectrum of FIG. 9 also shows a discrete spike at frequency fₚᵢₗₒₜ from the pilot tone. This portion of the spectrum is coherent and not noise-like. It does not drop in power as the resolution bandwidth is reduced. It comes from the pilot tone frequency and is coherent.

This embodiment may be deployed in a wavelength division multiplex network. This means that additional optical signals are present besides the one so far described. These signals have their own revenue data traffic, their own protocol artifacts, and their own pilot tones. The continuum noise of their data traffic adds to the continuum noise already described and can be reduced by detection bandwidth reduction. The protocol artifacts are at the SONET rates and avoidable as before. By virtue of assigning pilot tones at different frequencies, and by virtue of skipping SFR sweep frequencies that coincide with the pilot tones occurring on other optical signals, other pilot tones can be avoided. Thus, the multiple optical signal environment is similar but slightly noisier for the SFR reflectometry and dispersion measurement application described herein.

In the discussed embodiment of SFR-based reflection measurement and dispersion measurement, it is useful to have high signal to noise for each measurement of relative phase and amplitude of the transmitted and reflected pilot tone. This has been achieved in this embodiment by providing variable detection bandwidth at the transmit and reflected pilot tone detection locations. By positioning the pilot tones between the 8 KHz lines representing f_{framing} 905, and by selecting detection bandwidth sufficiently narrow to achieve a good signal to noise ratio, the distance and time resolution accuracy is maximized. The embodiment supports resolution bandwidths of less than 1 Hz, where the resolution bandwidth is driven by signal to noise.

The maximum signal to noise ratio achievable with the current embodiment is controlled by the phase noise of the pilot tone source and by the phase noise of the receivers. Alternative embodiments that tie frequency reference information between the pilot tone source and the receivers of transmitted and reflected optical signal allow cancellation of phase noise and reduce this limitation. Frequency accuracy then becomes a limitation.

To discern the pilot signal from data in the optical transmission path 120, a narrow band filter is employed. Because data is seen as noise over a broad bandwidth, a narrow band filter surrounding the frequency of the pilot tone is employed to reject most of the broadband noise while preserving the pilot tone signal. The bandwidth of this narrow filter is sufficiently narrow so as to achieve the signal to noise ratio appropriate for the required time resolution of the measurement being made, preferably a bandwidth of 1 Hz or less. Within this bandwidth, the data signal is seen as noise, and the pilot signal is seen as a strong signal. Thus, the signal-to-noise ratio of the pilot signal to data in the optical transmission path 120 is very high when measured over the 1 Hz bandwidth, resulting in the measurement of the pilot tone 310 being quite accurate. It should be understood that the filter may be analog and employed in the receivers 430 (FIG. 4A), or digital and employed in the processor 440 (FIG. 4A).

The preferred embodiment of the narrowband filter is in digital form, implemented as processor instructions, and has the advantage of ease of changing bandwidth to assist in maintaining required signal to noise. Adaptable bandwidth is useful because the time it takes to perform a measurement through a filter is inversely proportional to the bandwidth of the filter. Thus, there is a tradeoff between accuracy and speed of measurement. The preferred programmable embodiment eases execution of this tradeoff.

The preferred embodiment of the narrow band digital filters uses a time to frequency transformation. For example, a forward Fourier transform may be used to convert time data to multiple narrow band filter outputs, one of which outputs is the desired narrow band filtered signal output.

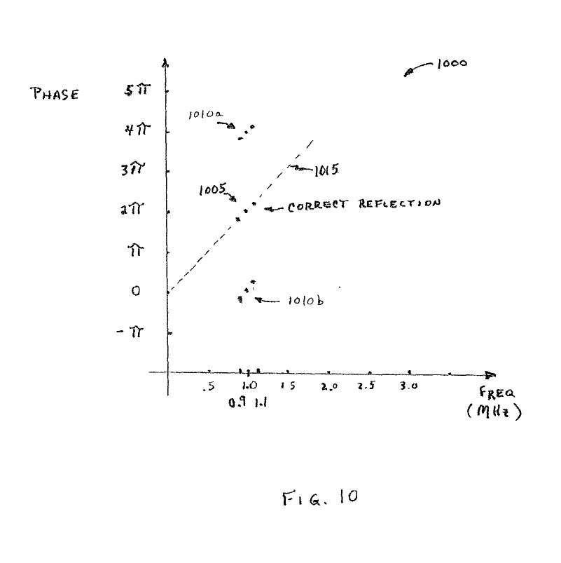

FIG. 10 graphically illustrates ambiguity in a phase measurement. The scatter plot 1000 includes sets of data points for pilot tones of 0.9 MHZ, 1.0 MHZ, and 1.1 MHZ. As expected, at 2nπ phases, where n=−2, −1, 0, 1, 2, . . . , a reflection is measured.

For example, the correct reflection is determined to be the set of data points 1005 at 2π and having a slope as indicated by a dashed line 1015. Two sets of ambiguous data points 1010a and 1010b do not project through the y-axis at zero on the x-axis and, therefore, are discarded as being erroneous sets of data points. The example in FIG. 10 is for a single reflection. In general and in practice, multiple reflections may be present in the propagation path being measured, and the phase of returned pilot tones are typically much more complex than shown in the example. In this more general case, amplitude information coupled with the phase information allows interpretation of the reflections into unambiguous reflections.

The frequency sweep is shown here as 0.9-1.1 MHZ, but in practice, the frequency sweep extends from 0.5 MHZ through about 2.5 MHZ. When performing the sweep, the sweep frequencies are selected to be frequencies essentially absent coherent modulations on the optical signal. For example, as previously stated, a framing signal is present at 8 kHz and has harmonics at every 8 kHz thereafter, including between 0.5 MHZ through 2.5 MHZ. Therefore, the sweep frequencies preferably exclude frequencies evenly divisible by 8 kHz to avoid these coherent modulations.

Using a maximum likelihood estimation technique, the phase slope of the distance of the reflection being sought is determined. Typically, maximum likelihood estimation techniques are signal-to-noise ratio dependent, which is why a 1 Hz or narrower bandwidth filter is employed. The maximum likelihood estimation technique provides selecting the sample points among the ambiguity of the 2nπ sample points shown in FIG. 10. Alternatively, a Fourier Transform technique may be employed to estimate the distance of the cause of the reflection.

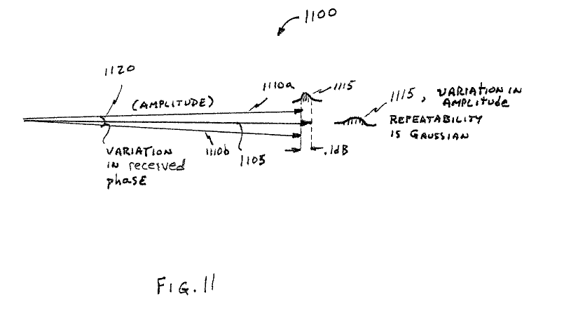

FIG. 11 is a vector diagram 1100 used to graphically represent repeatability for determining a position of a cause of a reflection (e.g., patch panel 305, FIG. 3). A noise free, error free sample is indicated by a center vector 1105. The top vector 1110a and bottom vector 1110b represent amplitude measurements resulting from noise or sampling-related errors. The observed repeatability of the embodiment, which is Gaussian as represented by Gaussian curve 1115, is about 0.1 dB, which is equivalent to 1% repeatability.

To determine the variation in angle amplitude 1120, which is represented as the full angle 1120 of the amplitude repeatability as shown, the repeatability is converted to an angle measurement. Thus, 1% amplitude repeatability can be converted to 0.01 radian angle repeatability and 0.01 radians×57 degrees/radian=˜0.6 degrees. Knowing that there are 360 degrees in a 1 MHZ signal traveling at approximately the speed of light, the following equation can be solved: 0.6 degrees/360 degrees/second*(1/1×10⁶ cycles/second)*3×10⁸ meters/second=˜0.5-1 meter. Thus, the resolution for determining the location of a cause of a reflection is about 0.5 meters.

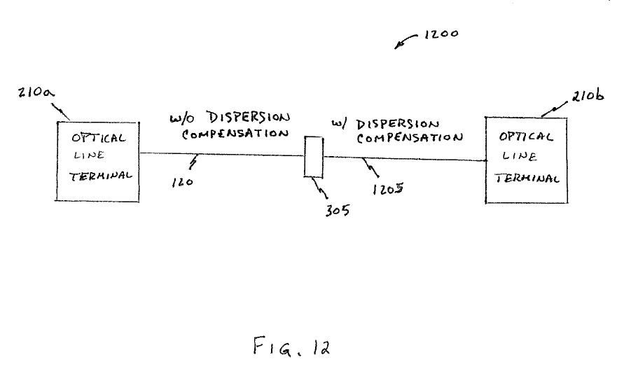

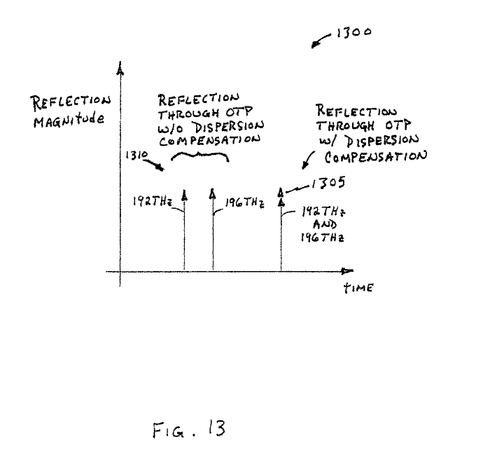

FIGS. 12 and 13 provide an example of an optical transmission path 120 having a first portion of the optical transmission path without dispersion compensation and a second portion of the optical transmission path having dispersion compensation. Referring to FIG. 12, the optical network 1200 includes the optical line terminals 210a and 210b with a patch panel 305 within the optical transmission path 120. Normally, non-dispersion compensated fiber in the optical transmission path 120 connects the first optical line terminal 120a to the patch panel 305. Beyond the patch panel 305, the optical transmission path 120 includes a dispersion compensation device 1205.

A pilot tone is provided on an optical signal as described above. Based on amplitude and phase of the reflections from the impairment in the patch panel and from the second optical line terminal 210b, the dispersion for the composite path of non-dispersion compensated optical transmission path 120 plus the patch panel 305 plus the dispersion compensation device 1205 may be measured.

FIG. 13 provides a time chart 1300 of intensities of reflections at optical frequencies corresponding to the optical network 1200 of FIG. 12. The reflections are detected by the detector/receiver 435 (FIG. 4A) in the first optical line terminal 210a, as discussed in reference to FIG. 4A. As shown, reflection results for two different optical frequencies are shown on the same graph, i.e. reflection for 192 THz and reflection for 196 THz. A first reflection 1310 for 192 THz corresponds to the reflection at 192 THz from the patch panel 305. A second reflection 1305 for 192 THz corresponds to the reflection from the optical line terminal 210b at 192 THz. A third reflection 1310 at 196 THz corresponds to the reflection from the patch panel 305 at 196 THz. And fourth reflection 1305 corresponds to the reflection from the optical line terminal 210b at 196 THz. The goal for dispersion compensation is to deliver optical signals without dispersion to the end receiver, in the FIG. 12 example, OLT 210b. The degree of coincidence of the second and fourth reflections is a measure of the total dispersion present in the optical transmission path 120 as experienced by OLT 210b.

The separation of the first and third reflections shows that the normal, non-dispersion compensated fiber has introduced dispersion in optical transmission path 120. As shown by the coincidence of the second and fourth reflections in FIG. 13, there is no total dispersion for the composite path made of the normal fiber transmission path 120 plus the patch panel 305 plus the dispersion compensation device 1205.

In the case where the dispersion compensation device 1205 provides for adjustable dispersion compensation, the results of reflection measurements may be used to guide adjustment of the dispersion compensation device 1205 by the coincidence of the second and fourth reflections, as discussed in reference to FIG. 6 and FIG. 7. In the embodiment shown, since the dispersion compensation device 1205 is remote from the optical line terminal 210a, instructions for an adjustment of the dispersion compensation device 1205 are transmitted to its location should the result providing the location of the dispersion measurement indicate a need for a dispersion adjustment. Such information transmission means and methods are known in the industry. For example, the information to adjust the dispersion compensation device 1205 can be conveyed by an optical supervisory channel (OSC) or by a network management communication path. Alternatively, the dispersion compensation device 1205 may be located within the optical line terminal 210a, in which case the control path for the dispersion compensation device 1205 may be simplified.

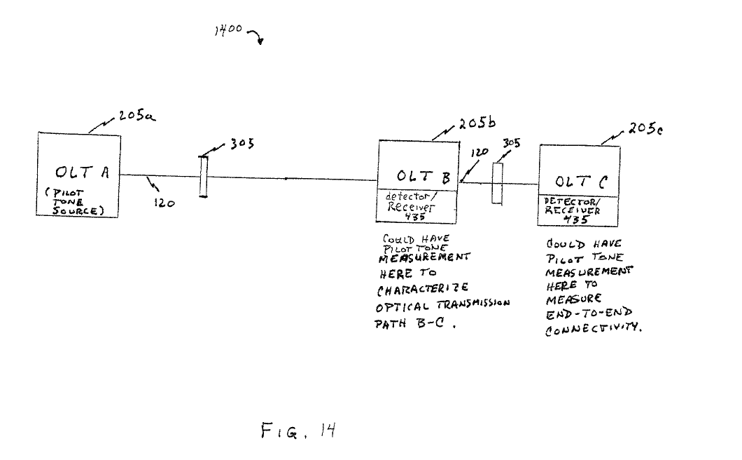

FIG. 14 is an example of another exemplary optical network 1400 having the three optical line terminals 205a, 205b, and 205c arranged sequentially. The first optical line terminal 205a includes a pilot tone source providing pilot tones on optical signals as described above. In the second optical terminal 205b, a detector/receiver 435 (FIG. 4A) is included, which characterizes the optical transmission path 120 between the second optical line terminal 205b and the third optical line terminal 205c. This characterization is possible for a relative measurement. In other words, the detector/receiver 435 detects the pilot tone traveling in the forward path of the optical transmission path 120 and reflections of the pilot tone traveling from the third optical line terminal 205c traveling in the reverse path of the optical transmission path 120. In this way, the detector/receiver 435 need not be co-located with the pilot tone source in the first optical line terminal 205a.

The third optical line terminal 205c can also have a detector/receiver 435 to detect the pilot tone. In this case, the measurement is being made to measure end-to-end connectivity.

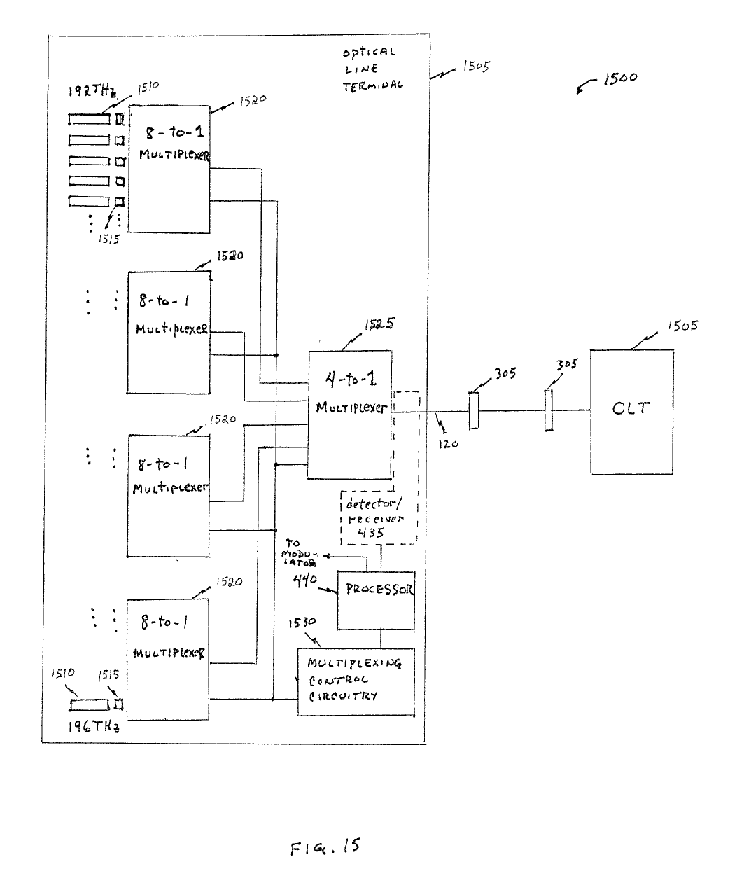

FIG. 15 is a block diagram of another optical network 1500 having optical line terminals 1505 with wavelength division multiplexed technology or time-division multiplexed technology. The multiplexing includes optical sources 1510 having optical frequency ranges between 192 THz and 196 THz, with a total of thirty-two channels. Following the sources are narrowband optical filters 1515 used to pass only the respective optical frequency of the associated optical source.

In the multiplexing arrangement, there are four 8-to-1 multiplexers 1520 that combine eight optical frequencies for passing to a 4-to-1 multiplexer 1525. This multiplexer 1525 combines the four composite optical inputs for simultaneous transmission of all 32 optical channels onto the optical path 120.

A processor 440 and/or multiplexer control circuitry 1530 is employed by the optical line terminal 1505 to provide the multiplexing logic and decision making that controls the multiplexers 1520 and 1525 and detector/receiver 435. The same processor 440 and/or circuitry 1530 may also be used to control the optical sources 1510 or external modulator (not shown) that provides the pilot tone for determining a location of a cause of a reflection along the optical transmission path 120 or dispersion in the same.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for characterizing an optical transmission path in a network with network traffic, the method comprising:
modulating an optical signal with a pilot tone and outputting the modulated optical signal onto the optical transmission path;
sweeping the pilot tone across a frequency range;
detecting amplitudes and phases of the pilot tone along a forward path and a reflected path of the optical transmission path; and
characterizing the optical transmission path based on the detected amplitudes and phases.

2. The method as claimed in claim 1 wherein the characterizing includes determining at least one impairment in the optical transmission path.

3. The method as claimed in claim 2 wherein the optical transmission path is a fiber; and
the determining includes determining a disconnection, crimp, obstruction, defect, or assembly error.

4. The method as claimed in claim 1 wherein the characterizing includes determining dispersion in at least a portion of the optical transmission path.

5. The method as claimed in claim 4 further including automatically correcting the dispersion.

6. The method as claimed in claim 1 wherein the detecting is co-located.

7. The method as claimed in claim 1 wherein the detecting is non-co-located across a length of the optical transmission path having a known characteristic.

8. The method as claimed in claim 1 wherein the sweeping of the pilot tone maximizes the spatial resolution of the measurements.

9. The method as claimed in claim 8 wherein the sweeping ranges between about 0.5 MHZ and about 2.5 MHZ.

10. The method as claimed in claim 1 wherein the sweeping includes selecting modulation frequencies essentially absent coherent modulations on the optical signal.

11. The method as claimed in claim 1 wherein the detecting of the pilot tone includes filtering the detected optical signal with a bandwidth sufficiently narrow to reject noise while preserving the pilot tone in a manner supporting accuracy requirements.

12. The method as claimed in claim 1 wherein the bandwidth of less than about 1 Hz.

13. The method as claimed in claim 1 wherein the detecting of the pilot tone includes filtering the detected optical signal with an adaptable bandwidth to allow tradeoff of signal to noise and associated accuracy versus detection time.

14. The method as claimed in claim 1 wherein the characterizing is based on a relative measurement of amplitudes and phases.

15. The method as claimed in claim 1 wherein the optical transmission path is a fiber.

16. The method as claimed in claim 1 used in a wavelength division multiplexed or time division multiplexed system.

17. An apparatus for characterizing an optical transmission path in a network with network traffic, the apparatus comprising:
a modulator that modulates an optical signal with a pilot tone and outputs the optical signal onto the optical transmission path carrying network traffic;
a sweep controller coupled to the modulator that causes the modulator to sweep the pilot tone across a frequency range;
a detection unit coupled to the optical transmission path and that detects amplitudes and phases of the pilot tone along a forward path and a reflected path of the optical transmission path; and
a processing unit responsive to the detection unit that characterizes the optical transmission path based on the detected amplitudes and phases.

18. The apparatus as claimed in claim 17 wherein the processing unit determines at least one impairment in the optical transmission path.

19. The apparatus as claimed in claim 18 wherein the optical transmission path is a fiber; and
the at least one impairment includes a disconnection, crimp, obstruction, non-uniformity, defect, or assembly error.

20. The apparatus as claimed in claim 17 wherein the processing unit determines dispersion in at least a portion of the optical transmission path.

21. The apparatus as claimed in claim 20 wherein the processing unit automatically causes a dispersion correction in response to determining the dispersion.

22. The apparatus as claimed in claim 17 wherein the detection unit includes at least one optical detector that senses the pilot tone and provides a corresponding electrical signal.

23. The apparatus as claimed in claim 22 further including a dual coupler coupled to the optical transmission path and connected to each optical detector, wherein the dual coupler provides between about 2% and 5% of the optical signal to the at least one optical detector.

24. The apparatus as claimed in claim 22 further including at least one receiver coupled to each optical detector to convert the electrical signal to digital data.

25. The apparatus as claimed in claim 24 wherein the processing unit employs a frequency to time transformation to assist in characterizing the optical transmission path.

26. The apparatus as claimed in claim 24 wherein the processing unit executes a time-to-frequency transformation to assist in characterizing the optical transmission path.

27. The apparatus as claimed in claim 22 wherein two optical detectors are co-located.

28. The apparatus as claimed in claim 22 wherein two optical detectors are non-co-located and separated by a portion of the optical transmission path having a known characteristic.

29. The apparatus as claimed in claim 17 wherein the sweep controller causes the modulator to sweep the pilot tone to maximize the spatial resolution of the measurements.

30. The apparatus as claimed in claim 17 wherein the sweep controller causes the modulator to sweep between about 0.5 MHZ and 2.5 MHZ.

31. The apparatus as claimed in claim 17 wherein the sweep controller selects modulation frequencies essentially absent coherent modulations on the optical signal.

32. The apparatus as claimed in claim 17 wherein the detection unit includes a filter to filter the detected optical signal with a bandwidth sufficiently narrow to reject noise while preserving the pilot tone as needed by the accuracy requirements.

33. The apparatus as claimed in claim 32 wherein the processing unit filters the optical signal with a bandwidth of less than about 1 Hz to detect the pilot tone.

34. The apparatus as claimed in claim 17 wherein the detection unit includes a filter having an adaptable bandwidth to allow tradeoff of signal to noise and associated accuracy versus detection time.

35. The apparatus as claimed in claim 17 wherein the processing unit characterizes the optical transmission path based on a relative measurement of the amplitudes and phases.

36. The apparatus as claimed in claim 17 coupled for use in a wavelength division multiplexed or time division multiplexed system.

37. An apparatus for characterizing an optical transmission path in a network with network traffic, the apparatus comprising:
means for modulating an optical signal with a pilot tone and for outputting the optical signal onto the optical transmission path carrying network traffic;
means for sweeping the pilot tone across a frequency range;
means for detecting amplitudes and phases of the pilot tone along a forward path and a reflected path of the optical transmission path; and
means for characterizing the optical transmission path based on the detected amplitudes and phases.

38. A computer-readable medium having stored thereon sequences of instructions, the sequence of instructions, when executed by a digital processor, causing the process to perform the steps of:
modulating an optical signal with a pilot tone, the optical signal being output onto an optical transmission path in a network with network traffic;
sweeping the pilot tone across a frequency range;
obtaining detected pilot tone amplitude and phase along a forward path and a reflected path of the optical transmission path; and
characterizing the optical transmission path based on the detected pilot tone amplitudes and phases.

39. A data communications system for characterizing an optical transmission path in a network with network traffic, the system comprising:
optical I/O providing data transfer across the optical transmission path; and
a swept frequency reflectometry subsystem including (i) a modulator to apply modulation to an optical signal across a frequency range in a swept manner, (ii) a detector coupled to the optical transmission path to detect the modulation along forward and reflected paths in the optical transmission path, and (iii) a processor coupled to the detector characterize the optical transmission path based on amplitudes and phases of the modulated optical signal in the forward and reflected paths.

40. The system as claimed in claim 39 wherein the processor determines at least one impairment in the optical transmission path.

41. The system as claimed in claim 39 wherein the processor determines dispersion in at least a portion of the optical transmission path.

42. The system as claimed in claim 41 wherein the processor causes a correction of the dispersion.

43. The system as claimed in claim 39 wherein the swept frequency reflectometry subsystem selects modulation frequencies essentially absent coherent modulations on the optical signal.

44. The system as claimed in claim 39 wherein the optical transmission path is a fiber.

45. The system as claimed in claim 39 wherein the optical I/O supports wavelength division multiplexing or time division multiplexing.
